(19) United States
(12) Patent Application Publication
(10) Pub. No.: US 2012/0281435 A1
(43) Pub. Date: Nov. 8, 2012

(54) DC-DC CONVERTER

(75) Inventors: Manfred Schlenk, Augsburg (DE); Jörg Oehmen, Riemerling (DE); Robert Weger, Wels (AT); Mykhaylo Raykhman, Munchen (DE)

(73) Assignee: Minebea Co., Ltd., Nagano-ken (JP)

(21) Appl. No.: 13/464,041

(22) Filed: May 4, 2012

(30) Foreign Application Priority Data
May 5, 2011 (DE) 102011100644.7

(51) Int. Cl. H02M 3/335

(52) U.S. Cl. 363/21.02

(57) ABSTRACT

A DC-DC converter (1) is provided having a resonant half-bridge circuit (2) and a transformer (TX1) that has a primary winding (P1) and a secondary winding (S1, S2) on a transformer core (4). The voltage converter (1) has a secondary circuit (3) with which the secondary winding (S1, S2) is associated and a switch (Q3, Q4) that is connected in series to the secondary winding (S1, S2), and a smoothing capacitor (C0, C01). The switch (Q3, Q4) is operated as a synchronous rectifier.

### CROSS-REFERENCE TO RELATED APPLICATIONS

This application claims the benefit of German Patent Application No. 10 2011 100 644.7, filed May 5, 2011, which is incorporated herein by reference as if fully set forth.

### BACKGROUND

The invention relates to DC-DC converters that are used to convert a DC voltage into a different DC voltage.

In the prior art, a large number of different circuit topologies for these kinds of DC-DC converters are known, such as flyback converters or other switching regulators.

In the case of a flyback converter, the DC voltage is initially converted into a high-frequency AC voltage which is then converted back again into a DC voltage. During this process, the voltage value may be either increased or decreased. In order to generate the AC voltage, the flyback converter has at least one switch which allows a square wave AC voltage to be initially generated from an input DC voltage.

However, high losses occur during switching at this primary-side switch, since switching always takes place at maximum current and thus high voltage peaks occur. It is therefore necessary to design the switches, generally semiconductor switches, for significantly higher voltages than the input voltage. Particularly in the case of flyback converters, the switches have to be designed for a significantly higher voltage due to the circuit topology. This makes the circuit expensive and more complex.

From U.S. 2010/0259241 A1, a half-bridge DC-DC converter is known in which smaller losses occur during switching.

One embodiment (originally FIG. 36a) of the above-mentioned document is shown in FIG. 1. The illustrated DC-DC converter has a transformer TX1 having a transformer core TK to galvanically isolate the primary and the secondary side. On the primary side, there is a series resonant circuit made up of the primary winding Np, an inductor Lr and a capacitor C1 that can be closed using a second switch Q2. Using a first switch Q1, the primary circuit can be connected to the input voltage Vg.

The secondary circuit on the secondary side has a series connection of the secondary winding Ns, a capacitor C2 and an inductor L, the inductor L also being disposed on the transformer core TK. Parallel to the secondary winding Ns, a rectifier diode CR is disposed between the capacitor C2 and inductor L. Furthermore, a smoothing capacitor CO is disposed at the output.

This arrangement is expensive, however, since an additional inductor L has to be laboriously integrated into the transformer or realized as an additional element. Due to the number of components, efficiency is reduced as well.

### SUMMARY

It is thus the object of the invention to create a DC-DC converter that has a simple and low-cost construction and yet exhibits exceptionally high efficiency.

This object has been achieved by a voltage converter in which the secondary circuit on the secondary side simply has a third switch, which is connected in series to the secondary winding, and a smoothing capacitor. This eliminates the need for a transformer winding and a capacitor, thus leading to a decrease in costs and an increase in efficiency.

The switches are preferably switched at the zero point of the current so that no significant switching losses occur. The transformer requires only one single primary and a secondary winding and can thus be easily manufactured at low-cost. The overall number of components is very low which is why efficiency is higher than in the prior art.

In operation, the second and third switches are always switched simultaneously and alternately to the first switch, since the third switch on the secondary side acts as a synchronous rectifier.

Moreover, due to zero point switching, the voltage requirement and voltage stress of the switches is reduced.

In this arrangement, the output voltage may be controlled through the duty ratio of the switch-on times of the first to the second switch. Shorter switch-on times of the first switch also go to reduce the output voltage.

The inductor of the series resonant circuit may be a simple coil with or without a coil core. The inductance of the series resonant circuit is preferably realized as leakage inductance of the transformer. This leads to a further reduction in the number of magnetic components, so that efficiency increases and the circuit can be manufactured at lower cost.

Depending on requirements, the transformer may have several secondary circuits, each having an associated secondary winding. By giving the secondary windings different numbers of turns, several different output voltages can be realized.

In principle, all electrically controlled switches are suitable for use as the switches. The switches are preferably realized using n-channel MOSFET switches. The body diode found in these switches ensures that loss-free zero voltage switching is possible in order to achieve higher efficiency. For other types of switches, appropriate diodes have to be provided separately.

### BRIEF DESCRIPTION OF THE DRAWINGS

The invention is explained in more detail below on the basis of the embodiments with reference to the enclosed drawings.

The figures show:

FIG. 1 a voltage converter according to the prior art,

FIG. 2 a circuit diagram of a DC-DC converter according to the invention, and

FIG. 3 the circuit of FIG. 2 having several output voltages.

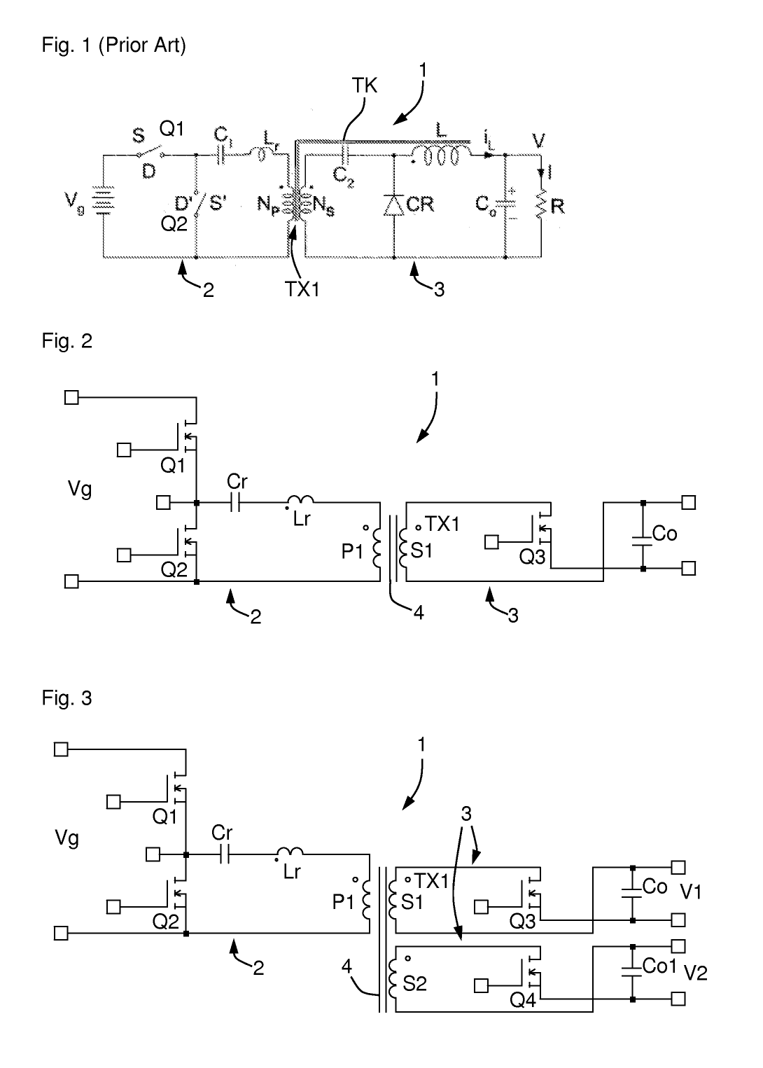

### DETAILED DESCRIPTION OF THE PREFERRED EMBODIMENT

FIG. 2 shows a DC-DC converter according to the invention, indicated in its entirety by 1, having a transformer TX1 having a primary winding P1 and a secondary winding S1 on a transformer core 4.

On the primary side 2, a series resonant circuit made up of a capacitor Cr, an inductor Lr and the primary winding P1 can be closed using a second switch Q2. The primary winding P1 can be connected to the input voltage Vg via a first switch Q1. The switches are preferably realized using n-channel MOSFETs.

The inductor Lr is preferably realized as leakage inductance of the transformer TX1, so that no additional magnetic component is required. A separate coil may, however, also be used.

In operation, the first switch Q1 and the second switch Q2 are always switched exactly alternately. By switching on the first switch Q1, energy is fed into the resonant circuit. The switch is operated, for example, at a frequency of 80 kHz. Switching preferably takes place at zero crossing of the current in the resonant circuit, so that the lowest possible switching losses occur. This also prevents any voltage peaks from occurring which is why the maximum load on the switches is the input voltage.

One important factor in determining the level of the output voltage V of the voltage converter 1 is the winding ratio of the primary winding P1 to the secondary winding S1. In the example, the primary winding has 110 turns and the secondary winding has 5 turns. On the other hand, it is possible to vary the output voltage V by changing the switch-on time of the first switch Q1. The shorter the switch-on time, the lower the output voltage V. In the example, the input voltage is Vg=400 VDC and the output voltage V=13 VDC.

On the secondary side of the transformer TX1, a secondary circuit 3 is disposed with which the secondary winding S1 is associated. The secondary circuit 3 has a third switch Q3, which is connected in series to the secondary winding S1, and a smoothing capacitor C0. The third switch Q3 is always switched exactly synchronous to the second switch Q2 and acts as a synchronous rectifier.

Except for the transformer TX1, the overall circuit according to the invention does not have any other magnetic components, which is why magnetic losses are lower compared to the prior art. Since the overall number of components is kept low, the circuit is also more cost-effective.

FIG. 3 shows a further development of the voltage converter according to the invention of FIG. 2 used to provide two or more different output voltages. For this purpose, the transformer TX1 of the voltage converter 1 has several secondary windings S1, S2, with each of which an identical secondary circuit 3, each having a third switch Q3, Q4 and a smoothing capacitor C0, C01, is associated.

In the example, the circuit has two secondary windings S1 and S2 that may have different numbers of turns, so that different output voltages V1 and V2 occur. Accordingly, two separate secondary circuits 3 are provided, each being associated with a secondary winding S1, S2.

Identification Reference List
1 DC-DC converter circuit
2 Primary side
3 Secondary circuit
4 Transformer core
Vg input DC voltage
Q1 First switch
Q2 Second switch
Q3,Q4 Third switch
Cr;C1 Capacitor series resonant circuit
Lr Inductor series resonant circuit
TX1 Transformer
TK Transformer core
Np;P1 Primary winding
Ns;S1,S2 Secondary winding
C2 Capacitor secondary side
CR Rectifier diode secondary side
L Coil secondary side
C0,C01 Smoothing capacitor
V,V1,V2 Output voltage
R Load

1. A DC-DC converter (1) comprising a transformer (TX1) that has a primary side (2) and a secondary side, wherein on the primary side (2) a series resonant circuit that can be closed using a second switch (Q2) is formed that includes a primary winding (P1) of the transformer (TX1), a capacitor (Cr), and an inductor (Lr), the primary winding (P1) is connectable using a first switch (Q1) to a input voltage (Vg), and wherein at least one secondary winding (S1; S2) is disposed on the secondary side, each being associated with a secondary circuit (3), the secondary circuit (3) has a third switch (Q3, Q4) acting as a synchronous rectifier, which is connected in series to the secondary winding (S1; S2), and a smoothing capacitor (CO, C01) and the second switch (Q2) and the third switch (Q3, Q4) are always switched simultaneously and alternately to the first switch (Q1).

2. A DC-DC converter according to claim 1, wherein the inductor (Lr) of the series resonant circuit is realized as leakage inductance of the transformer (TX1).

3. A DC-DC converter according to claim 1, wherein the transformer (TX1) has a plurality of the secondary circuits (3) each having a respective one of the secondary windings (S1, S2).

4. A DC-DC converter according to claim 1, wherein the switches (Q1, Q2, Q3, Q4) comprise n-channel MOSFET switches.

5. A DC-DC converter according to claim 1, wherein the switches (Q1, Q2, Q3, Q4) are switched in a zero crossing of current in the series resonant circuit of the primary side (2).
